(19) United States
(12) Patent Application Publication
(10) Pub. No.: US 2011/0203120 A1
(43) Pub. Date: Aug. 25, 2011

(54) RAZOR CARTRIDGE ASSEMBLY

(76) Inventor: Stephen Charles Witkus, Northbridge, MA (US)

(21) Appl. No.: 13/029,299

(22) Filed: Feb. 17, 2011

Related U.S. Application Data
(60) Provisional application No. 61/307,019, filed on Feb. 23, 2010.

(51) Int. Cl. B26B 21/54; B23P 15/44

(52) U.S. Cl. 30/346.58; 29/428

(57) ABSTRACT

The invention discloses a novel razor cartridge including a housing having a top, front and back areas, and a bottom, and a plurality of posts each having an end portion extending towards the housing bottom and at least one blade disposed in the housing. Each blade includes a cutting edge and a bottom portion having front and back sides wherein the bottom portion of the blade is disposed adjacent at least one of the plurality of posts. The posts are desirably made of plastic. The end portions of the posts are crushed to provide contact and support to the front and/or back side of the bottom portion of the blades in the housing. The crush force may be up to about 100 lbs-force and the posts are reduced in height by about 20% to about 95%. The crushed posts retain the blades in the housing restricting fore and aft blade movement.

### CROSS REFERENCE TO RELATED APPLICATION

This application claims the benefit of U.S. Provisional Application No. 61/307,019, filed Feb. 23, 2010.

### FIELD OF THE INVENTION

This invention relates to razor cartridges, and more particularly to razor cartridge assembly.

### BACKGROUND OF THE INVENTION

As it is known in the art, wet shave razor cartridges have many components that need to be assembled. These components generally include a cartridge housing, a plurality of blades having blade edges, a guard in front of the blades, a cap area having a shaving aid or lubricating strip (e.g., most commonly referred to as a lubrastrip) in back of the blades, two end clips, one on each end of the blades and optionally a trimmer blade.

The assembly of these numerous components may generally be costly and in addition may also result in cartridges without optimal shaving performance. For instance, oftentimes, the blades vibrate or “chatter” during shaving, the blade alignment can shift, and in addition, the rinse-ability of the cartridge may be restricted.

Thus there is a need to improve the current shaving experience by desirably minimizing assembly and alignment issues of a razor cartridge and provide for a more open architecture that results in more rinse-ability.

### SUMMARY OF THE INVENTION

The invention provides a housing having a top, front and back areas, and a bottom, and a plurality of posts each having an end portion extending towards the housing bottom and at least one blade, each of the at least one blades comprising a cutting edge and a bottom portion having front and back sides, wherein each blade optionally comprises a blade carrier, the bottom portion of the at least one blade disposed adjacent at least of one of the plurality of posts and wherein the end portions of the plurality of posts are crushed providing contact and support to the front and/or back side of the bottom portion of at least one of the blades or of one of the blades comprising the blade carriers in the housing.

In another embodiment of the present invention, a method of manufacturing a razor cartridge includes the steps of providing a housing having a top, front and back areas, and a bottom, and a plurality of posts each having an end portion extending towards the housing bottom; and disposing at least one blade in the housing, each the at least one blade comprising a cutting edge and a bottom portion having front and back sides, wherein each blade optionally comprises a blade carrier, into the housing, the bottom portion of the at least one blade disposed adjacent at least one of the plurality of posts; crushing the end portions of the plurality of posts to provide contact and support to the front and/or back side of the bottom portion of at least one of the blades or of one of the blades comprising the blade carriers in the housing.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

While the specification concludes with claims particularly pointing out and distinctly claiming the subject matter which is regarded as forming the present invention, it is believed that the invention will be better understood from the following description which is taken in conjunction with the accompanying drawings in which like designations are used to designate substantially identical elements, and in which:

FIG. 1 is a cross-sectional side view of a conventional razor cartridge.

FIG. 2 is a cross-sectional side view of a razor cartridge of the present invention.

FIG. 2A is a close-up view of FIG. 2.

FIG. 2B is a perspective view of the razor cartridge of FIG. 2 shown attached to a handle.

FIG. 3 is the cross-sectional side view of the razor cartridge of FIG. 2 showing posts of the present invention facing upward.

FIG. 4 is a top view of FIG. 3.

FIG. 5 is a cross-sectional side view of FIG. 3 depicting an anvil disposed on the posts of the present invention.

FIG. 5A is a photograph of a mechanical apparatus showing a close-up view of the anvil of FIG. 5.

FIG. 6 is a top view of FIG. 5 after an initial force is applied with the anvil of FIG. 5.

FIG. 7 is a side view of FIG. 6.

FIG. 8 is a top view of FIG. 5 after an additional force is applied with the anvil of FIG. 5.

FIG. 9 is a side view of FIG. 7.

FIG. 10 is a close-up view of FIG. 9.

FIG. 11 is a cross-sectional side view of an alternate embodiment of the present invention.

### DETAILED DESCRIPTION OF THE INVENTION

The invention provides new components and methods to improve the shaving performance of multi-blade razors by introducing into the razor cartridge, novel posts to provide contact and support to the blades (and/or metal blade carriers) by restricting fore and aft blade movement and shifting, which, in turn, reduces the amplitude of blade vibration (“chatter”) and/or deflection during shaving thereby improving shaving performance.

The term “crush” or “crushed” or “crushing” as used in the present invention signifies the pressing or the squeezing with a force that destroys or deforms. Thus, the novel aspects of the present invention will apply equivalently to the terms “crush” or “press” or “deform” and may be used interchangeably in the following description.

The “crushing” of the present invention may be achieved manually or automatically. For instance, the crushing may be achieved by hammering an anvil or other heavy block with a smooth face, desirably made of steel. The crushing may also be achieved via automated machines such as mechanical assembly equipment of the type known in the art for manufacturing razor cartridges which in turn may provide more consistent cartridge structures,

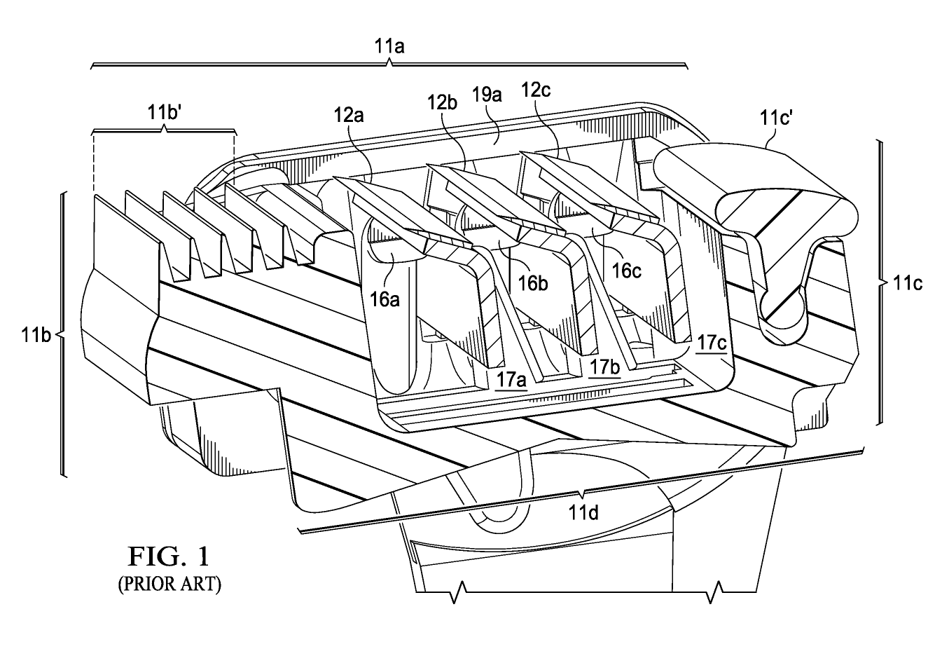

As shown in FIG. 1, an illustrative embodiment of one type of conventional razor cartridge 10 is provided including three blades 12a, 12b, and 12c respectively disposed in slots 15a, 15b, and 15c formed within a housing 11. The housing 11 has a top area 11a, a front area 11b which may desirably comprise a guard 11b′ and a back area 11c which may desirably comprise a lubricating strip or cap portion 11c′ and a bottom area 11d. The blades 12a, 12b and 12c are generally loaded from the top area 11a of the housing 11 onto spring members (e.g., leaf springs) 16a, 16b, and 16c disposed in the housing. As can be seen in FIG. 1, bottom portions 12a″, 12b″ and 12c″ of the blades 12a, 12b, and 12c respectively are also supported by back walls 17a, 17b, and 17c respectively. Back wall 17c may as depicted in FIG. 1 be the rear wall in the back area 11c of the housing 11 rather than being a separate structure (e.g., back walls 17a and 17b).

The springs 16a, 16b, and 16c may desirably compress slightly (e.g., about 0.20″) when the blades are loaded into the housing. Generally, two clips 19a and 19b (19b not shown) retain both ends of the blades (at either end of the blades) from a top area 11a of the housing 11. When clips 19a and 19b are placed on the blades, the blades 12a, 12b, and 12c desirably spring back. Thus, a tension is desirably provided between the leaf springs 16a, 16b, and 16c disposed in the housing and the clips provided on top of the blades 12a, 12b, and 12c.

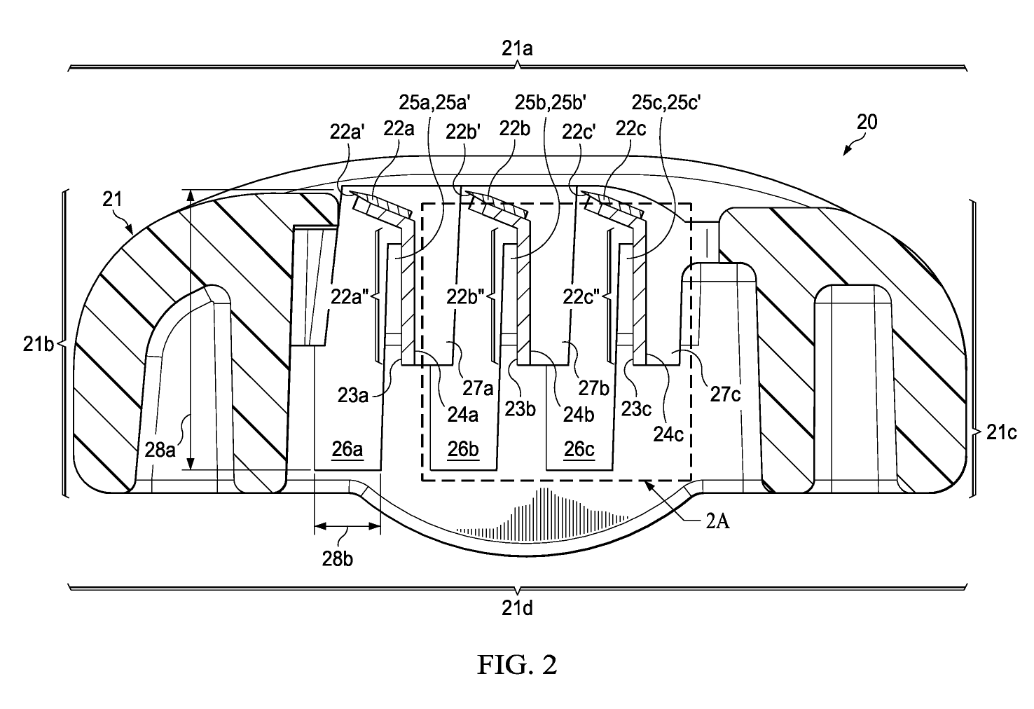

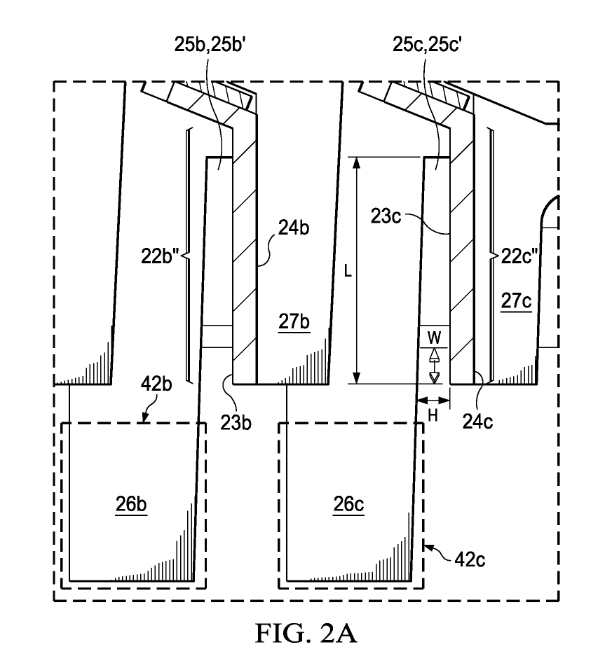

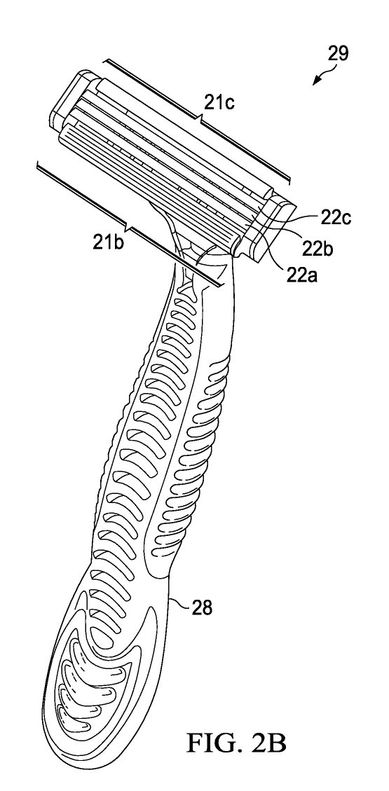

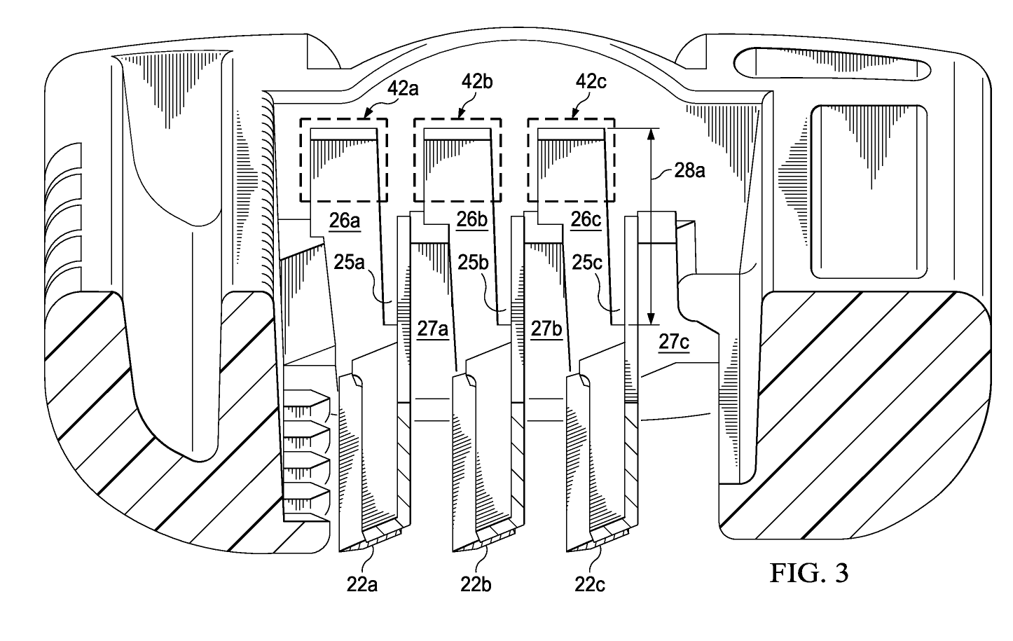

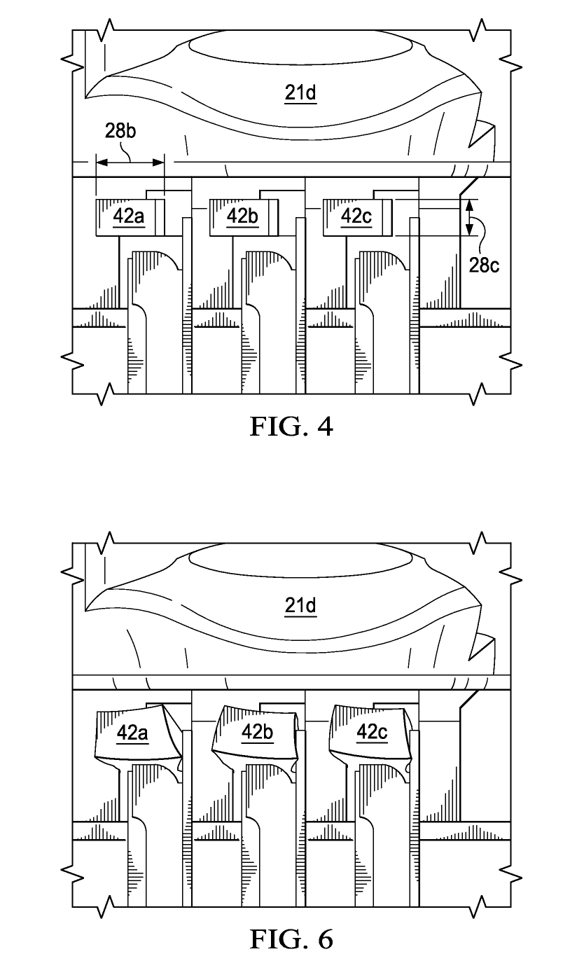

Referring now to FIG. 2, a razor cartridge 20 is provided including three blades 22a, 22b, and 22c respectively disposed in slots 25a, 25b, and 25c formed within a housing 21 in accordance with the present invention. The housing 21 has a top area 21a, a front area 21b which may desirably comprise a guard and a back area 21c which may desirably comprise a lubricating strip or cap portion and a bottom area 21d. The housing 21 also includes posts 26a, 26b, and 26c and back walls 27a, 27b, and 27c. Posts 26a, 26b, and 26c are depicted in their initial state or prior to crushing (e.g., prior to the application of any force). The initial height 28a shown in FIGS. 3 of posts 26a, 26b, and 26c may desirably range from about 1 mm to about 4 mm and desirably be about 2 mm. As shown in FIG. 4, the initial length 28b of the posts may generally range from about 0.50 mm to about 1 mm and the initial width 28c may range from about 0.3 mm to about 0.7 mm.

The housing, posts, and back walls may be made of the same or different materials and may each be made of more than one type of material. Advantageously, the housing, posts and back walls are made from one of the same type of material and more desirably, a polymeric material whereby the housing and its components may be injection molded. For instance, polymeric materials contemplated in the present invention may include, but are not limited to, plastics such as High Impact Polystyrene (HIPS) or Acrylonitrile Butadiene Styrene (ABS) or other materials known to those of skill in the art.

Each blade generally includes a cutting edge and a bottom portion having front and back sides. Specifically, blade 22a has a cutting edge 22a′ and a bottom portion 22a″ with a front side 23a and a back side 24a, blade 22b has a cutting edge 22b′ and a bottom portion 22b″ with a front side 23b and a back side 24b, and blade 22c has a cutting edge 22c′ and a bottom portion 22c″ with a front side 23c and a back side 24c. As shown, the back sides 24a, 24b, and 24c of the bottom portions 22a″, 22b″ and 22c″ may each contact or rest up against a back wall 27a, 27b, and 27c, respectively. Slots 25a, 25b and 25c have open areas 25a′, 25b′ and 25c′ as shown in FIG. 2A which remain between the posts and the blade bottom portions after blades are inserted in the slots but prior to crushing. The open areas 25a′, 25b′ and 25c′ of slots 25a, 25b, and 25c may generally be defined as having a length L of about 1.4 mm to about 1.7 mm, a width W of about 1.1 mm to about 1.4 mm and a height H of about 0.2 mm to about 0.5 mm.

The blades of the present invention may desirably be bent blades or blade support assemblies (BSAs), the latter comprising a blade having a cutting edge mounted onto a blade support or blade carrier. The blades depicted in FIG. 2 each include a blade 22a, 22b, and 22c with a cutting edge 22a′, 22b′ and 22c′ respectively with a blade support or carrier 29a, 29b and 29c respectively encompassing the bottom portion. Thus, the bottom portions 22a″, 22b″, and 22c″ of the blades in FIG. 2 comprise blade supports 29a, 29b and 29c which are attached to the blades 22a, 22b and 22c. The blades of FIG. 2 may desirably be loaded into the housing slots 25a, 25b, and 25c from the bottom area 21d of the housing 21.

In the present invention, each of the blades' bottom portions' back sides 24a, 24b, and 24c may desirably also be adjacent to, in contact with or rest against or support at least one surface of back walls 27a, 27b, and 27c respectively when initially placed within the housing. Each back wall may also be adjacent to, in contact with or support at least one surface of each of the posts. The back walls 27a, 27b, and 27c may also desirably be formed as described above in conjunction with the posts with analogous dimensions except that the back walls may desirably be shorter in height than the height of the posts.

Though supported by the back walls 27 on the back sides 24 of their bottom portions 22a″, 22b″, and 22c″, the blades 22a, 22b, and 22c may likely still be capable of moving within the slots of the housing and in particular shifting towards the front area 21b of the housing 21 since they are generally not adequately supported on their front sides 23a, 23b, 23c. Too much blade movement may be undesirable, as mentioned above, as it may increase the amplitude of blade vibration (“chatter”) and/or the blade deflection.

Thus, as will be described herein, the novel posts of the present invention, once crushed, will provide the capability of restricting fore and aft blade movement, which, in turn, may desirably reduce the amplitude of blade vibration and/or deflection during shaving. By reducing either the blade deflection or the blade vibration (“chatter”), overall shaving performance is improved.

It should be noted that though three blades are depicted in FIG. 2, the present invention contemplates having any number of razor blades, e.g., one or more. Additionally, the invention contemplates at least one post and at least one back wall formed within the housing. Additionally, by molding the housing slots at different heights, angles, or spans, the blades of the present invention may be set to any exposure, angle or span desired.

FIG. 2A depicts the razor cartridge 20 of FIG. 2 operatively coupled to a handle 28 at the bottom area 21d of the housing 21 to provide a functional razor 29. In the present invention, the razor may be entirely disposable or the razor may include a reusable handle with a disposable cartridge.

Referring now to FIG. 3, a flipped or upside down view of FIG. 2 is shown where the bottom area 21d of the housing 11 is facing upward rather than facing downward as it was depicted in FIG. 2. FIG. 4 is a top view of FIG. 3 depicting the end portions 42a, 42b, and 42c of the posts 26a, 26b, and 26c. The end portions of the posts in FIG. 4 are depicted as having a desirably flat and roughly rectangular or square shaped upper surface area though any upper surface area or feasible shape is contemplated in the present invention for the upper surface areas, or the end portions or the entire posts. The end portions 42a, 42b, and 42c may desirably encompass a substantial portion of the posts 26a, 26b, and 26c as shown, for instance, in FIGS. 2A and 3.

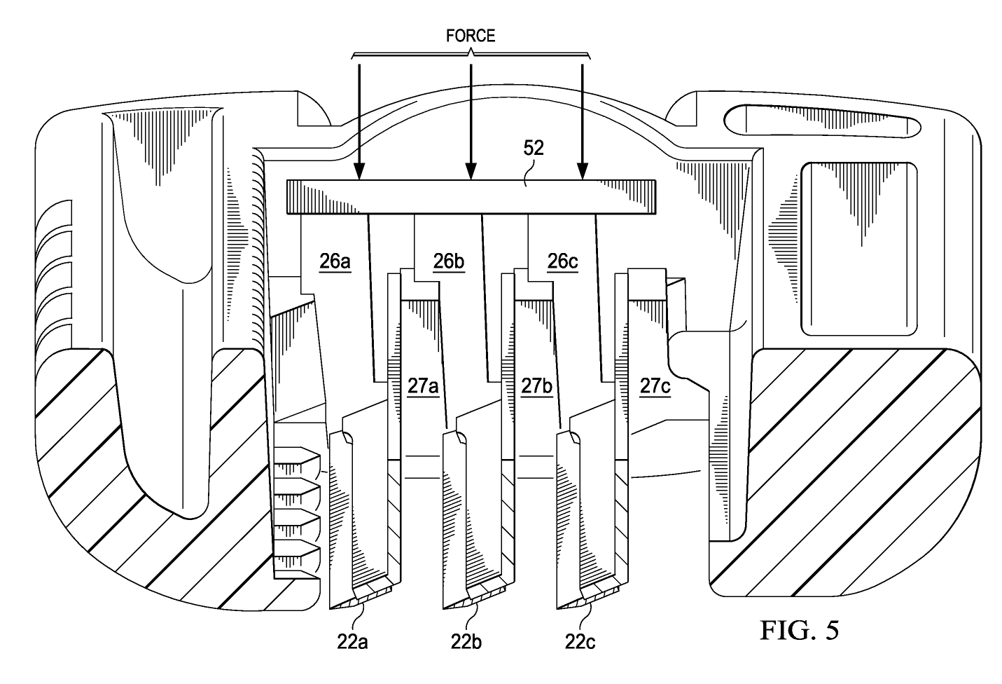

FIG. 5 depicts an anvil 52 which may be a rectangular metal block (e.g., iron block) placed on the upper surfaces of the end portions 42a, 42b, and 42c of the posts 26a, 26b, and 26c having initial heights and prior to the application of any force. After a force F is applied to the anvil 52, the end portions 42a, 42b, and 42c and the initial posts 26a, 26b, and 26c begin to deform slightly.

Referring now to FIG. 5A, a staking press type of mechanical apparatus, for providing a force F, a combination of a force F1 and a force F2, to the posts is shown, in accordance with the present invention, having an arm 54 which may be manually pulled down by a user. The force F1 is produced by moving or pulling arm 54 down. The arm 54 movement downward substantially simultaneously lowers the anvil 52 which is aligned on top of the cartridge housing 21, producing force F2 on the posts on each side of the housing. The anvil 52 is lowered to crush the posts and stopped immediately after. Generally, in the present invention, applied force F1 may desirably be less than about 5.0 lbs applied and more desirably about 2.0 lbs to about 3.0 lbs of force may be applied. However, force F2 at the location of crushing F2, may likely be significantly larger than the force F1 required for pulling the arm 54 down. The actual applied force F of the anvil on the posts may desirably be from about 30 to 70 lbs-force or 100 lbs-force or more. The present invention contemplates other mechanical or non-mechanical structures which may be implemented to crush the posts, and thus contemplates requiring larger or smaller forces (e.g., conceivably less than 2 lbs-force or greater than 100 lbs-force) depending on the design.

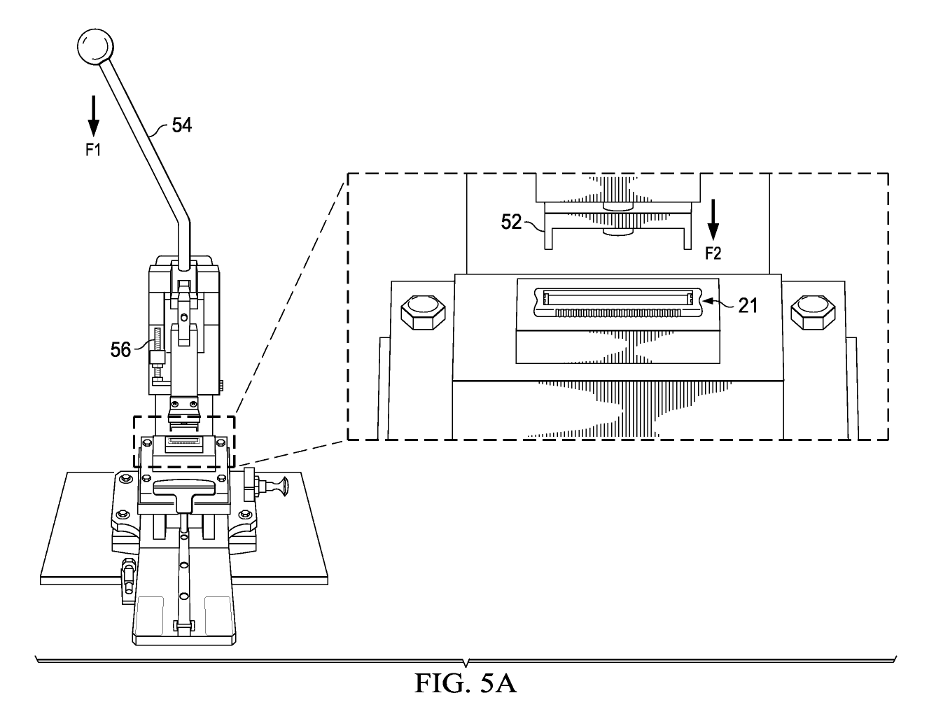

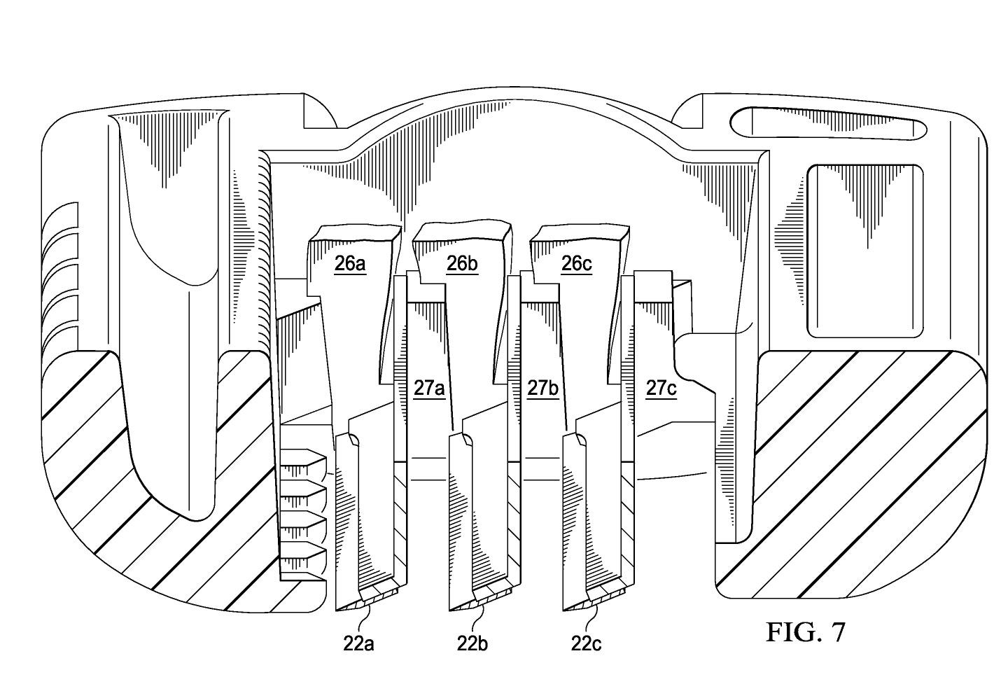

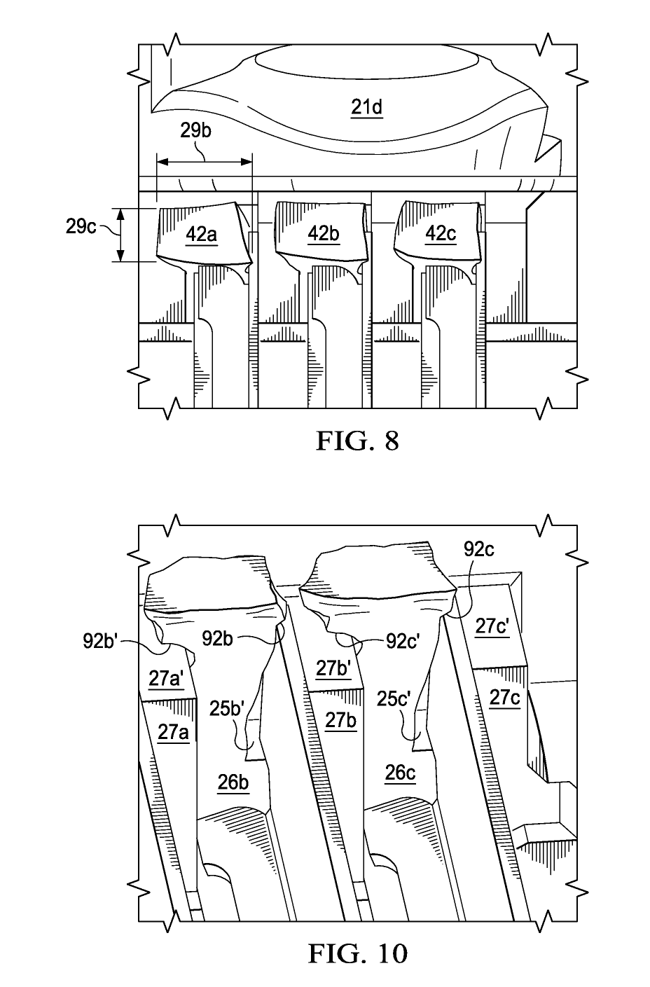

This initial deformation is depicted (with the anvil removed) in the top view of the razor cartridge 20 of FIG. 6 and in the side view of FIG. 6 shown in FIG. 7. As can be seen in FIG. 6, the crushing or deformation of the posts may produce a wider upper surface area on the end portions of the posts as can be observed in that the square perimeter of upper surface area has been distorted. This is described below with regard to final length and final widths in FIG. 8. Additionally, as can be seen in FIG. 7, at this point, after crushing, there has also a reduction in the height of the posts.

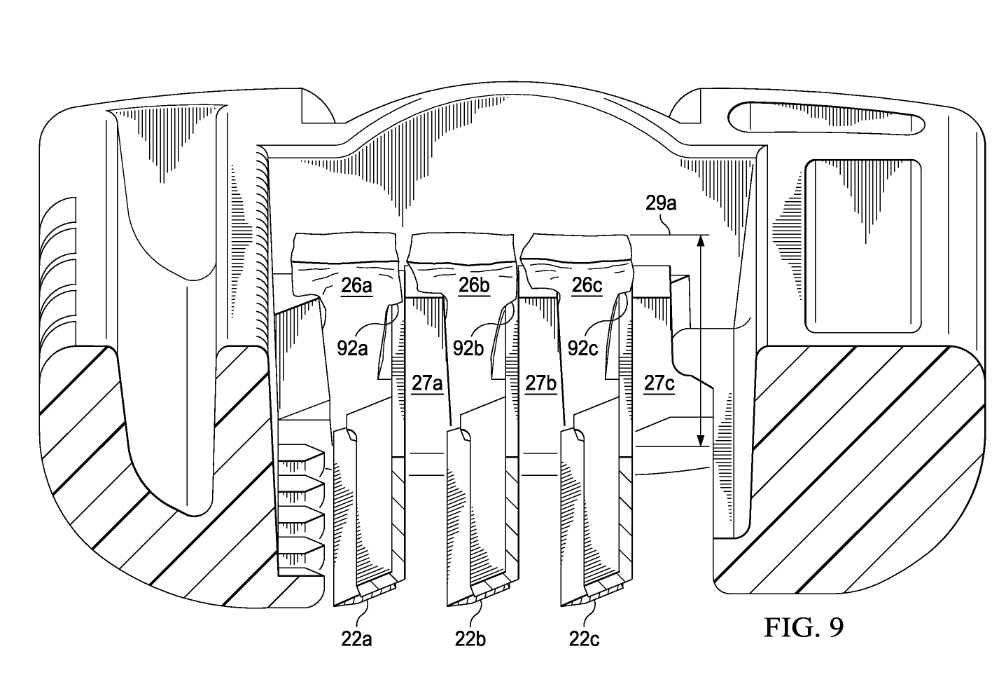

As the force F is continued to be applied, the end portions 42a, 42b, and 42c of the posts 26a, 26b, and 26c deform even more as depicted (anvil removed) in the top view of the razor cartridge 20 of FIG. 8 and in the side view of FIG. 8 depicted in FIG. 9. As can be seen in FIG. 9, the posts are now significantly deformed, have buckled or collapsed down, and have each wedged into the open areas 25a′, 25b′, and 25c′ of the slots 25a, 25b, and 25c in the housing, effectively pushing or pinning via front sides 23a, 23b, and 23c of the blades' bottom portions 22a″, 22b″, and 22c″ respectively against the respective back walls 27a, 27b, and 27c as shown at blade contact regions 92a, 92b, and 92c. Contact regions 92a, 92b, and 92c depict the location where the posts 26a, 26b, and 26c cover the blades (or specifically the blade bottom portions, 22a″, 22b″, and 22c″ respectively) to retain them in the housing 21.

Blade contact regions 92a, 92b, and 92c may be formed as a point of contact, a line desirably having a length of about 0.05 mm to about 3 mm, or more desirably a relatively small area encompassing about 0.0025 mm² or 9 mm². Generally, for each of the posts, the blade contact regions 92a, 92b, and 92c will have similar contact dimensions. The blade contact regions 92a, 92b, and 92c may also be in contact with the back walls 27a, 27b, and 27c or upper surfaces of the back walls 27a′, 27b′, and 27c′, respectively.

But for a small portion in each of the open areas 25a′, 25b′ and 25c′, the posts, after being crushed, may desirably substantially completely fill up these open areas respectively.

It should be noted that generally, after crushing, the end portions of the posts may conceivably also flow over and contact the back wall of an adjacent post, forming back wall contact regions 92a′, 92b′ and 92c′. For instance, as depicted in FIG. 10, crushed post 26c forms back wall contact region 92c′ with upper surface 27b′ of back wall 27b and crushed post 26b forms back wall contact region 92b′ with upper surface 27a′ of back wall 27a (partially shown). The dimensions of these regions may generally be slightly larger than the dimensions of the blade contact regions. These back wall contact regions may assist in retaining the blades or keeping the blades down in their respective slots.

The posts may be crushed or deformed beyond the elastic limit of the polymeric (e.g., plastic) material. The elastic limit of polymeric material is a function of the elasticity of the material. Elasticity is the ability of a material to return to its original shape, or dimensions, after a load or stress is removed. In the present invention the posts will deform when the force F or other load is applied and more desirably the plastic strain herein will occur above the elastic limit in that the material will not fully recover (e.g., the posts will not return to original dimensions (e.g., length) after the force is removed) or otherwise stated, the posts have undergone a permanent deformation.

The actual deformation or the crushing of the posts in a cartridge of the present invention may generally be visible or discernible to a user when observing the blade slot ends of the housing.

Desirably, the posts 26a, 26b, and 26c of the present invention may each have a final height 29a as shown in FIG. 9 of about 0.5 mm or less, (e.g., from about 0.05 mm to about 0.00 mm) and desirably be about 0.1 mm. The final height 28b of each of the posts may desirably be approximately the same. Referring to end portions 42a, 42b, and 42c in FIG. 8 of the posts 26a, 26b, and 26c, the final length 29b of the posts after crushing may range from about 1.0 mm to about 1.3 mm and the final width 29c after crushing may range from about 0.70 mm to about 0.80 mm and desirably be about 0.75 mm. The final length and width of the posts may be slightly larger in dimensions than the initial length and width (before crushing), whereas, after crushing the final height of the posts is more desirably smaller than the initial height of the posts.

As noted in FIG. 5, the force F may be applied at one or more points on the anvil 52 and desirably simultaneously applied to each of the posts. To deform the posts in nearly the same manner, roughly the same force F may necessarily have to be applied throughout the anvil 52 to affect each post similarly. In some instances, depending on the type of material that is to be used for the posts, a larger force F may be necessary for crushing. For instance, a larger force (e.g., greater than about 100 lbs-force) may be needed to produce the desired deformation of materials like nylon, Noryl® or other materials generally known to have a higher ratio of stress to strain, or greater tendency to bend (e.g., having a high flexural modulus) as opposed to HIPs or ABS.

A stop may be set to control the crush distance (e.g., to stop the force of the anvil). The stop may be implemented manually or automatically via mechanical or other known feasible methods. For instance, the stop may be a screw and nut adjustment 56 on the staking press (shown in FIG. 5A) or on the anvil (not shown). The crush distance may be an amount comparable to the amount of reduction in height of the posts.

Since the crushing force generally increases significantly as the anvil reaches the upper surface of the back walls 27a′, 27b′, and 27c′, a stop may also be set up to crush the post until a specific force value is reached. For instance, when the post is completely collapsed or crushed, the anvil may be in contact with the upper surface of the back walls or other ribs in the housing. At this point, the force has increased significantly (e.g., conceivably up to about 200%) from its initial value and the stop may be triggered to remove the load, signifying the completion of the compression of the posts.

In this embodiment, where the initial height of the posts is about 2 mm and the final height of the posts may be about 0.5 mm, generally, the percentage reduction in height after the applied force may be appreciated to be about 75%.

The present invention considers the percentage reduction in height of the posts may desirably be from about 20% to about 95% or even 100% if posts are crushed entirely and more desirably from about 40% to about 75%.

The present invention also contemplates a different force being applied to each individual post. This may be potentially accomplished with three different anvils, each anvil situated above each different post where each anvil may have a different force applied to it thereby providing less consistent or different types of deformations and/or varied final heights of the posts.

It should be noted that other ways to apply a force or forces to the posts, simultaneously or otherwise, is/are contemplated in the present invention such as, but not limited to, automated assembly equipment including robotic or nozzles capable of applying the crushing force or other feasible mechanical means known or capable of being applied in the razor arts.

The end portions 42a, 42b, and 42c of the posts 26a, 26b, and 26c after crushing (e.g., the initial posts after crushing or having a final height) may be on or about the same plane as upper surface of the back walls 27a, 27b, and 27c of the housing. Generally, the height or other dimensions of the back walls may desirably be unaffected by the crushing force.

Depending on the extent of the deformation and the wedged contact, the blades may either be retained in the slots in a fixed manner (not allowed to budge) or they may be allowed some slight movement about the slots. Generally, it may be more desirable that the blades not be capable of moving or shifting around in the slots. By effectively pinning or wedging the blades against the back walls of the housing in the present invention, the crushed posts desirably provide the capability of restricting fore and aft blade movement in the housing slots, which, in turn, may desirably reduce the amplitude of blade vibration and/or deflection during shaving. By reducing either the blade deflection or the blade vibration (“chatter”), overall shaving performance is generally improved.

Accordingly, FIGS. 9 and 10 represent an advantageous embodiment of the present invention, in that the posts are crushed to the point of being capable to aptly retain the blades within the housing.

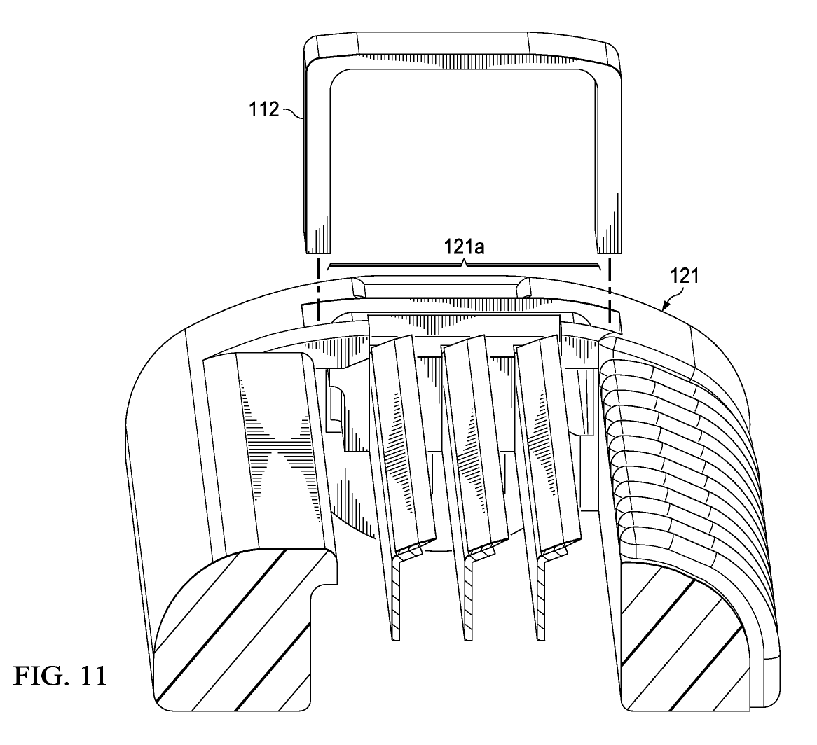

In addition, the present invention provides a simplified structure by not necessarily requiring clips or spring fingers or welding structures to retain the blades in the housing as is typical of many prior art razor cartridges. Consequently, having a less complicated structure with fewer components may also likely beneficially lower some manufacturing and assembly costs. However, clips may be used in the present invention, in addition to the crushed posts, to provide greater security in the retention of the blades in the housing. An alternate embodiment of the present invention showing a top view of one side of a cartridge housing 121 and how one clip 112 on that side would be inserted from a top area 121a of the housing 121 over the blades is depicted in FIG. 11.

Additionally, though not shown, the present invention contemplates other embodiments which may have posts which are otherwise compressed or deflected and then folded over or pushed from one position to another to retain the blades in place. For instance, the posts may be somewhat curved or bent in the housing initially, (e.g., before being crushed), requiring less crush force to obtain optimal retention of the blades in the housing structure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
a housing having a top, front and back areas, and a bottom, and a plurality of posts each having an end portion extending towards the housing bottom; and
at least one blade, each said at least one blade comprising a cutting edge and a bottom portion having front and back sides, wherein each blade optionally comprises a blade carrier, said bottom portion of said at least one blade disposed adjacent at least of one of said plurality of posts;
wherein each of said end portions of said plurality of posts are crushed providing contact and support to the front and/or back side of said bottom portion of at least one of the blades or of one of the blades comprising said blade carriers in said housing.

2. The razor cartridge of claim 1 wherein said end portions are crushed from said housing bottom area.

3. The razor cartridge of claim 1 wherein, prior to said crushing, an initial height of said plurality of posts ranges from about 1 mm to about 4 mm, an initial length ranges from 0.50 mm to about 1 mm, and an initial width ranges from about 0.3 mm to about 0.7 mm.

4. The razor cartridge of claim 1 wherein, after said crushing, said posts are reduced in height by about 20% to about 95%.

5. The razor cartridge of claim 1 wherein said posts are reduced in height by about 1.0 mm to about 1.7 mm.

6. The razor cartridge of claim 1 wherein said posts are comprised of plastic.

7. The razor cartridge of claim 5 wherein said plastic comprises High Impact Polystyrene (HIPS) or Acrylonitrile Butadiene Styrene (ABS), nylon, Noryl® or any combination thereof.

8. The razor cartridge of claim 1 wherein said posts are crushed using a force of up to about 100 pounds.

9. The razor cartridge of claim 1 wherein each of said end portions of said plurality of posts is crushed using a staking press.

10. The razor cartridge of claim 1 wherein each of said end portions of said plurality of posts is crushed using an anvil.

11. The razor cartridge of claim 10 wherein said staking press comprises a stop.

12. The razor cartridge of claim 12 wherein said stop comprises a screw and nut adjustment.

13. The razor cartridge of claim 1 wherein said at least one blade is not movable within said housing after said end portions of said plurality of posts are crushed.

14. The razor cartridge of claim 1 wherein said posts and said end portions may be comprised of any shape.

15. The razor cartridge of claim 1 housing further comprises at least one back wall adjacent the front and/or back side of said bottom portion of said at least one blade.

16. The razor cartridge of claim 1 wherein said at least one blade is loaded into said housing from said housing bottom.

17. The razor cartridge of claim 1 wherein said at least one blade is retained in said housing via at least one end clip.

18. A method of manufacturing a razor cartridge comprising the steps of:
providing a housing having a top, front and back areas, and a bottom, and a plurality of posts each having an end portion extending towards said housing bottom; and
disposing at least one blade in said housing, each said at least one blade comprising a cutting edge and a bottom portion having front and back sides, wherein each blade optionally comprises a blade carrier, into said housing, said bottom portion of said at least one blade disposed adjacent at least one of said plurality of posts;
crushing each of said end portions of said plurality of plastic posts from said housing bottom area to provide contact and support to the front and/or back side of said bottom portion of at least one of the blades or of one of the blades comprising said blade carriers in said housing.

19. The method of claim 18 wherein, after said crushing, said posts are reduced in height by about 20% to about 95%.

20. The method of claim 18 wherein said crushing is achieved via a force of up to about 100 lbs.

21. The method of claim 18 wherein, after said crushing, said at least one blade is not movable within said housing.
